(19) United States
(12) Patent Application Publication
(10) Pub. No.: US 2025/0273386 A1
(43) Pub. Date: Aug. 28, 2025

(54) PLANAR INDUCTOR STRUCTURE WITH INTEGRATED SHIELDING TO CONTAIN ELECTRIC FIELD

(71) Applicant: VIRGINIA TECH INTELLECTUAL PROPERTIES, INC., Blacksburg, VA (US)

(72) Inventors: Tyler McGrew, Blacksburg, VA (US); Qiang Li, Blacksburg, VA (US)

(21) Appl. No.: 19/061,004

(22) Filed: Feb. 24, 2025

Related U.S. Application Data
(60) Provisional application No. 63/556,982, filed on Feb. 23, 2024.

(51) Int. Cl. H01F 27/28; H01F 27/24

(52) U.S. Cl. CPC H01F 27/2885; H01F 27/24

(57) ABSTRACT

An example planar inductor includes a winding structure including a plurality of conductive windings arranged in layers of a printed circuit board (PCB) around a core, where the plurality of conductive windings include at least a top winding and a bottom winding. The planar inductor includes a conductive shield encasing the winding structure. The conductive shield includes an upper conductive shield layer disposed over the winding structure in a first direction, a lower conductive shield layer disposed under the winding structure in a second direction opposite the first direction, an inner conductive shield disposed within and around the plurality of conductive windings, and an outer conductive shield disposed around and outside the plurality of conductive windings.

### CROSS-REFERENCE TO RELATED APPLICATIONS

This application claims the benefit of and priority to U.S. Provisional Patent Application No. 63/556,982, filed Feb. 23, 2024, entitled “PLANAR INDUCTOR STRUCTURE WITH INTEGRATED SHIELDING TO CONTAIN ELECTRIC FIELD,” the entire content of which is hereby incorporated herein by reference in its entirety.

### BACKGROUND

By adopting wide-bandgap (WBG) power devices using silicon carbide (SIC) or gallium nitride (GaN) material, switch-mode power converters are able to achieve high power density while maintaining good efficiency. Compared to Si power devices, these WBG devices experience reduced switching losses, enabling a higher switching frequency and the use of smaller passive energy storage components within the converter. However, the use of high switching frequency, along with the fast turn-on and turn-off speed of WBG devices, can worsen the electromagnetic interference (EMI) emissions generated by power converters. To ensure compliance with electromagnetic combability (EMC) regulations, suppressing the EMI emissions generated by power converters while achieving the desired power density and efficiency is important.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 depicts a cross-sectional schematic of an example planar inductor implementing conductive shielding using shield layers and conductive edge plating according to various embodiments of the present disclosure.

FIG. 2 depicts a cross-sectional printed circuit board (PCB) schematic of an example inductor structure implementing the conductive shield shown in FIG. 1, according to various embodiments of the present disclosure.

FIG. 3 depicts a perspective view of a planar inductor implementing the inductor structure shown in FIG. 2 according to various embodiments of the present disclosure.

FIG. 4 depicts a cross-sectional schematic of an example planar inductor with an alternative implementation of a conductive shield using conductive shield rings located co-planar with inductor windings, according to various embodiments of the present disclosure.

FIG. 5 depicts a cross-sectional PCB schematic of an example inductor structure implementing the conductive shield shown in FIG. 4 according to various embodiments of the present disclosure.

FIG. 6 depicts a perspective view of a planar inductor implementing the inductor structure shown in FIG. 5 with a view of an alternative implementation of the conductive shield layers using patterned conductive features according to various embodiments of the present disclosure.

FIG. 7 depicts a sectional view of the planar inductor shown in FIG. 6 including inductor windings, conductive shield rings, and conductive patterned shield layers according to various embodiments of the present disclosure.

FIG. 8 depicts a planar inductor with a patterned conductive shield implemented with a UI shaped core according to various embodiments of the present disclosure.

### DETAILED DESCRIPTION

Power converters in many applications utilize buck, boost, or buck-boost topologies, and other topologies are known. In these converters, the power inductor is often a primary component that adversely affects electromagnetic compatibility (EMC). This is attributable to the strong electric and magnetic fields generated by power inductors. These fields couple into other areas of the circuit, forming parasitic inductive and capacitive couplings which generate conducted EMI noise. In particular, common mode (CM) conducted noise is increased when the electric field from the inductor forms capacitive couplings with other areas of the converter circuit.

According to the embodiments, a planar inductor is inclusive of a printed circuit board (PCB) based planar inductor. A metallic shield may be used to enclose the inductor (e.g., winding structures and magnetic core) and contain its electric field to improve EMC. In this regard, the conductive or metallic shields of inductors are generally implemented using metallic enclosures external to the PCB windings and core. However, the use of such a shielding enclosure complicates manufacturing which increases cost and design complexity. Therefore, it is desirable to integrate conductive shielding within the planar power inductor structure using standard printed circuit board (PCB) manufacturing processes. In this way, the integrated shielded inductor could be adopted to improve EMC with minimal impact on system cost and complexity.

The embodiments described herein include a planar inductor implementing a winding structure using integrated shielding or conductive shields to contain the electric field of the inductor. The inductor according to the embodiments can be partially or entirely implemented using standard PCB manufacturing processes, to provide a simple and inexpensive realization. This concept effectively contains the electric field of the planar inductor, which can greatly reduce the EMI emissions when adopted in a switch-mode power converter. The planar inductor integrating conductive shields can further be designed in a way to minimize eddy currents in the shield to avoid increasing power loss. The planar inductor according to the embodiments can be implemented at a low-cost with convenient manufacturing due to its ability to be integrated with a PCB. The conductive shields can effectively contain electric fields with minimal power loss.

In the context outlined above, a planar inductor according to the embodiments includes a winding structure including a plurality of conductive windings arranged in layers of a PCB around a core. The plurality of conductive windings include at least a top winding and a bottom winding. The planar inductor also includes a conductive shield encasing the winding structure. The conductive shield includes an upper conductive shield layer disposed over the winding structure in a first direction, a lower conductive shield layer disposed under the winding structure in a second direction opposite the first direction, an inner edge shield plate disposed within the plurality of conductive windings, and an outer edge shield plate disposed around and outside the plurality of conductive windings.

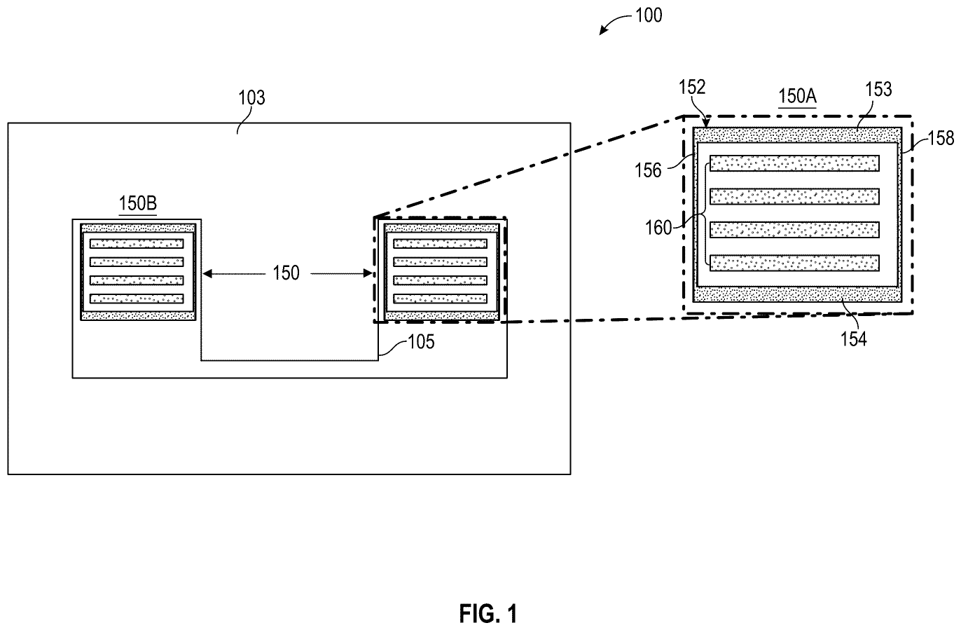

Referring now to the drawings, FIG. 1 depicts a cross-sectional schematic of an example planar inductor 100 implementing conductive shielding using shield layers and conductive edge plating according to various embodiments of the present disclosure. The planar inductor 100 is illustrated as a representative example and is not drawn to any particular size or scale. The planar inductor 100 is depicted to introduce the concepts of planar (e.g., PCB-implemented) inductor structures with integrated shields. The concepts described herein can be extended to a range of different inductor structures, several of which are described below.

The planar inductor 100 shown in FIG. 1 can be implemented in a PCB with other power conversion components or can alternatively be implemented in a separate PCB and electrically coupled to other power conversion components of a power converter. For example, the planar inductor 100 can be a power factor correction (PFC) inductor used to improve the efficiency and stability of power supplies or other power converters, especially in switch-mode power supplies (SMPS). The planar inductor 100 can be used with a variety of power converter topologies such as buck, boost, and buck-boost, among others. The planar inductor 100 can be implemented in the same PCB with semiconductor switches, gate drivers, signal processing sensors, and alternating current (AC) line EMI filters, among others. As mentioned above, the planar inductor 100 does not have to be implemented in the same PCB with these other components but it may be beneficial to implement the planar inductor 100 in the same PCB as the other components from efficiency, manufacturing, and cost perspectives.

The planar inductor 100 can be configured to contain electric fields emanating or emitted from a winding structure of the planar inductor 100 by way of a conductive shield that encases the winding structure. The conductive shield is a metallic shield that can be configured to contain the electric fields and prevent parasitic electromagnetic couplings between the planar inductor 100 and other nearby power conversion components, as mentioned above. For example, the conductive shield can prevent parasitic capacitive coupling from the planar inductor 100 to an EMI filter, thereby reducing EMI and switching noise of a power converter. Or, the conductive shield can prevent parasitic capacitive coupling from the planar inductor 100 to auxiliary gate-drive and sensing circuitry, thereby decreasing interference with these circuits and improving the reliability of a power converter. It should be noted that the planar inductor 100 and its implementations shown in FIG. 1 is not exhaustively illustrated, meaning that other components not shown in FIG. 1 can be included or relied upon in some cases. Similarly, one or more components shown in FIG. 1 can be omitted in some cases.

The planar inductor 100 includes a core 103 and an inductor structure 150. The inductor structure 150 can be implemented using a PCB, as described below, and the core 103 can be implemented with one or multiple pieces such that it can be positioned around and, in some cases, through openings in the PCB. The inductor structure 150 includes a winding structure 160 and a conductive shield 152. The winding structure 160 includes a plurality of conductive windings (“windings”) that can be arranged in layers of a PCB around the core 103. The inductor structure 150 adopts or tracks a substantially or circular shape and is positioned around a central leg 105 of the core 103. In other words, inductor structure portion 150A and inductor structure portion 150B, which are structurally identical, are positioned around the central leg 105. Based on the structure of the core 103, which is an EQ shaped core in this case, the inductor structure 150 can track different shapes such as oval, square-like, octagonal, rectangular, and hexagonal, among others. The core 103 is a magnetic core and can be embodied as a material of high magnetic permeability, such as a ferromagnetic material like iron, laminated silicon steel, laminated iron sheets, or other solid or laminated ferromagnetic ceramic, metal, metal alloy, or related material(s).

The windings of the winding structure 160 include metallic windings such as copper windings and can include an arrangement of individual windings with each winding being implemented in a separate metallic layer or trace of the PCB. In some cases, multiple windings can be implemented in the same metallic layer. In FIG. 1, the windings of the winding structure 160 include four windings implemented in four separate metallic layers of the PCB and arranged around the core 103, but the winding structure 160 is not limited to four windings and can include less than or greater than four windings. The core 103 can include an EQ shaped core as stated above. However, the planar inductor 100 is not limited thereto, and the windings can be designed to be arranged around different types of cores such as a UI shaped core and other types of cores.

The planar inductor 100 includes the conductive shield 152. The planar inductor 100 encloses or encases the winding structure 160. So that the conductive shield 152 can effectively encase or completely enclose the winding structure 160, a geometric shape of the conductive shield 152 tracks or adopts a geometric shape of the winding structure 160. For example, if the winding structure 160 tracks a circular shape, the conductive shield 152 can track a circular shape.

The conductive shield 152 is a metallic shield and can be formed from the same materials and components as the individual windings of the winding structure 160, such as copper or copper traces in a PCB board. The conductive shield 152 includes an upper conductive shield layer 153, a lower conductive shield layer 154, an inner edge shield plate 156, and an outer edge shield plate 158. The upper conductive shield layer 153, the lower conductive shield layer 154, the inner edge shield plate 156, and the outer edge shield plate 158 can all be electrically coupled to each other, and function to contain electric fields emanating from the planar inductor 100 to mitigate undesirable electromagnetic couplings to other components and conductors within the power converter. For example, the conductive shield 152 can function to contain electric fields emanating from the planar inductor 100 during a power conversion operation to prevent parasitic capacitive coupling from the planar inductor 100 to an EMI filter and other auxiliary circuits that can be present within a power converter such as gate drivers and sensing circuits, thereby decreasing interference with these circuitries and improving reliability of the power converter. The conductive shield 152 can be manufactured with the planar inductor 100 as an integrated metallic shield using standard PCB manufacturing processes, to improve EMC with minimal impact on system cost and complexity.

The upper conductive shield layer 153 is disposed over the winding structure 160 in a first direction. For example, the upper conductive shield layer 153 can be implemented in a metallic layer of a PCB above a metallic layer of an uppermost or a top winding of the winding structure 160. The lower conductive shield layer 154 is disposed under the winding structure 160 in a second direction opposite the first direction. For example, the lower conductive shield layer 154 can be implemented in a metallic layer of a PCB below a metallic layer of a lowermost or a bottom winding of the winding structure 160. The inner edge shield plate 156 is disposed within the conductive windings of the winding structure 160 and positioned adjacent to the central leg 105. The outer edge shield plate 158 is disposed around and outside of the conductive windings of the winding structure 160 and positioned away from the central leg 105.

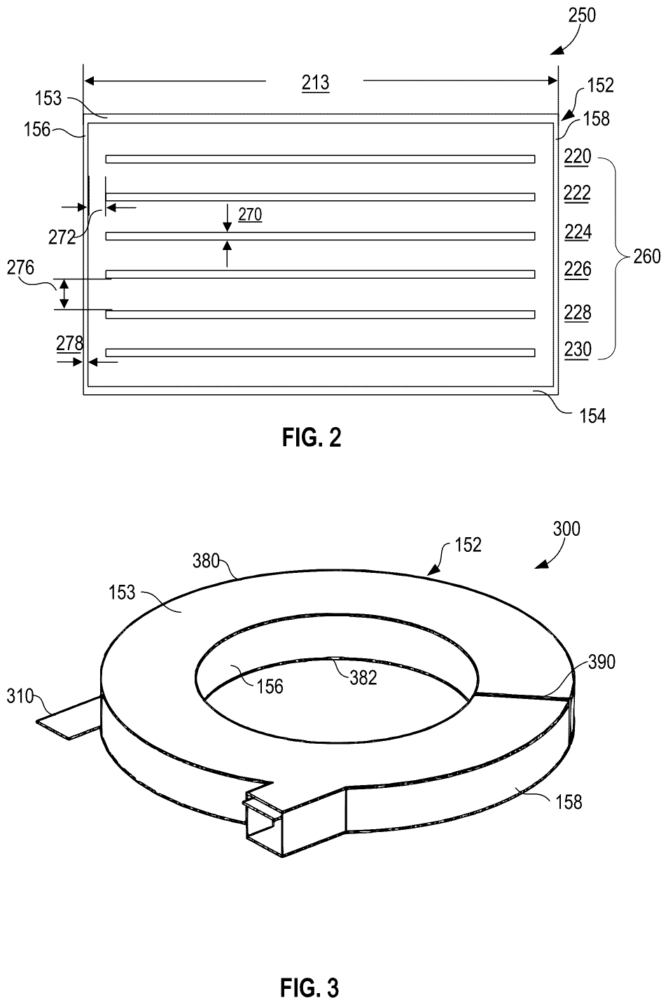

The upper conductive shield layer 153 and the lower conductive shield layer 154 are substantially equal in thickness to each other and to a thickness of an individual winding of the windings of the winding structure 160, in at least one example. The inner edge shield plate 156 and the outer edge shield plate 158 are substantially equal in thickness to each other and have thicknesses lower in value than thicknesses of the upper conductive shield layer 153 and the lower conductive shield layer 154. The upper conductive shield layer 153 and the lower conductive shield layer 154 can be implemented or integrated with conductive metal traces, disposed vertically with respect to the top and the bottom conductive windings of the winding structure 160, to prevent electric fields of the planar inductor 100 from escaping vertically through the PCB. The edge shield plates 156 and 158 are implemented lateral to the winding structure 160 to prevent electric fields of the planar inductor 100 escaping laterally through the PCB and can be implemented by PCB edge plating process or other means. Further description regarding the conductive shield 152 is provided below with respect to FIGS. 2 and 3.

FIG. 2 depicts a cross-sectional PCB schematic of an example inductor structure implementing the conductive shield shown in FIG. 1, and FIG. 3 depicts a perspective view of a planar inductor implementing the inductor structure shown in FIG. 2, according to various embodiments of the present disclosure. An inductor structure 250 is similar to the inductor structure portions 150A or 150B but includes six conductive windings 220, 222, 224, 226, 228, and 230 (“windings 220-230”), as parts of a winding structure 260, instead of four windings in the inductor structure 150. The inductor structure 250 can be implemented in the planar inductor 100 shown in FIG. 1. The inductor structure 250 includes the conductive shield 152, which encases or completely encloses the winding structure 260.

The upper conductive shield layer 153 is disposed over the winding structure 260 in a first direction. For example, the upper conductive shield layer 153 can be implemented in a metallic layer of a PCB above the winding 220, which is a top winding of the winding structure 260. The lower conductive shield layer 154 is disposed under the winding structure 260 in a second direction opposite the first direction. For example, the lower conductive shield layer 154 can be implemented in a metallic layer of a PCB below the winding 230, which is a bottom winding of the winding structure 260. The inner edge shield plate 156 is disposed within and around the windings 220-230 of the winding structure 260 and can be positioned adjacent to the central leg 105. The outer edge shield plate 158 is disposed around and outside of the windings 220-230 of the winding structure 260 and can be positioned away from the central leg 105.

The windings 220-230 are separated from the inner edge shield plate 156 by an edge clearance 272. The windings 220-230 are separated from each other by a dielectric thickness 276. Each of the windings 220-230 has a winding thickness 270, which can vary based on manufacturer specifications or based on the application of the inductor structure 250. In one example, the winding thickness 270 can range from 17 microns to 140 microns, commensurate with about a half ounce (oz) copper to four oz copper for each of the windings 220-230. The inner edge shield plate 156 and the outer edge shield plate 158 each has an edge shield plate thickness 278, which is less than the winding thickness 270. The conductive shield 152 has a winding window 213, which defines the total cross-sectional width of the inductor winding structure 250 including windings, conductive shielding, and associated clearances.

Referring to FIG. 3, a planar inductor 300 tracks a circular shape and can include the inductor structure 250 or the inductor structure 150. The planar inductor 300 is similar to the planar inductor 100 and can be positioned around the central leg 105 of the core 103. The inner edge shield plate 156 is disposed lateral to the winding structure 260, which is implemented in the planar inductor 300. The inner edge shield plate 156 extends circularly within the winding structure 260 and forms an inner circumference 382 of the conductive shield 152. The outer edge shield plate 158 is disposed lateral to the winding structure 260, extends circularly around and outside the winding structure 260, and forms an outer circumference 380 of the conductive shield 152. The conductive shield 152 encases or completely encloses the winding structure 260 to contain the electric fields emanating from the planar inductor 300.

The conductive shield 152 includes a termination 310 which can be used to connect to an input voltage (Vᵢₙ) or output voltage (Vₒ) terminal such as a direct current (DC) or alternating current (AC) terminal of a power converter. The conductive shield 152 includes a separation or a cut 390 that extends completely from an edge of the outer circumference 380 to an edge of the inner circumference 382 including separation of the inner edge shield plate 156, the outer edge shield plate 158, the upper conductive shield layer 153, and the lower conductive shield layer 154. The cut 390 physically separates the conductive shield 152 into two parts with respect to the termination 310 to prevent eddy currents and circulation of large current that could potentially flow around the loop formed by the conductive shield 152, which could otherwise degrade or destroy its performance.

The upper conductive shield layer 153 and the lower conductive shield layer 154 are generally equal in thickness to each other and may be equal, greater than, or less than the thickness of an individual winding of the windings of the winding structure 160. The inner edge shield plate 156 and the outer edge shield plate 158 are generally equal in thickness to each other and have thicknesses lower in value than thicknesses of the upper conductive shield layer 153 and the lower conductive shield layer 154. The upper conductive shield layer 153 and the lower conductive shield layer 154 can be implemented or integrated with conductive metal traces vertically with respect to the top and the bottom conductive windings of the winding structure 160, to prevent electric fields of the planar inductor 100 from escaping vertically from the PCB. The edge shield plates 156 and 158 can be implemented or integrated with conductive edge plating implemented lateral to the winding structure 160 to prevent electric fields of the planar inductor 100 escaping laterally through the PCB.

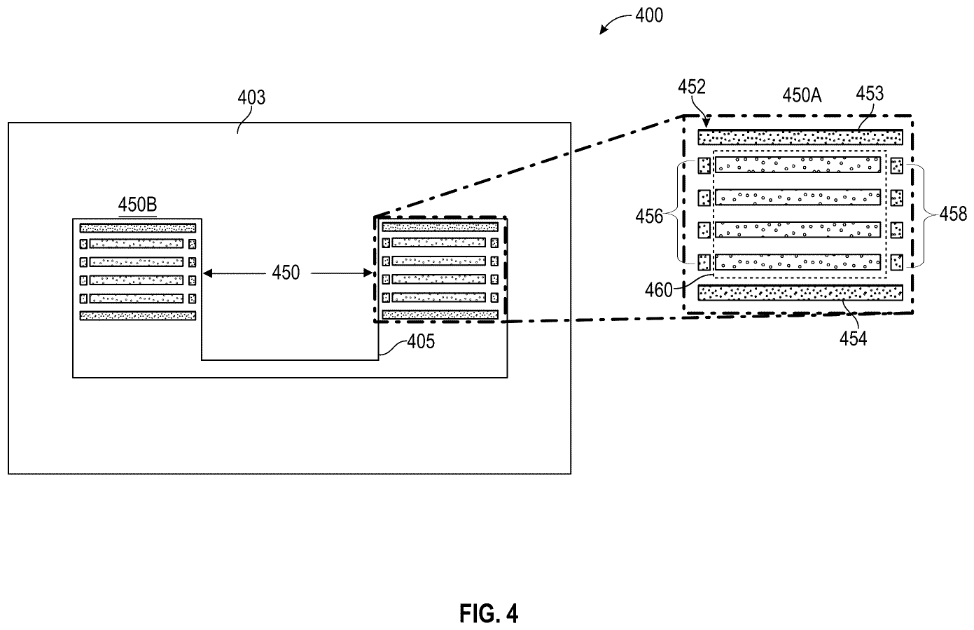

FIG. 4 depicts a cross-sectional schematic of an example planar inductor with an alternative implementation of a conductive shield using conductive shield rings located co-planar with inductor windings, according to various embodiments of the present disclosure. A planar inductor 400 can be implemented in a PCB with other power conversion components or can alternatively be implemented in a separate PCB and electrically coupled to other power conversion components of a power converter, such as a buck, boost, or buck-boost converter. The planar inductor 400 is not exhaustively illustrated, meaning that other components not shown in FIG. 4 can be included or relied upon in some cases. Similarly, one or more components shown in FIG. 4 can be omitted in some cases. The planar inductor 400 is similar or substantially identical to the planar inductor 100 but includes multiple conductive inner shield rings and outer shield rings located co-planar with inductor windings of a winding structure, in contrast with the solid conductive edge plating used for the inner edge plate 156 and the outer edge plate 158 shown in FIG. 1.

The planar inductor 400 includes a core 403 and an inductor structure 450, which includes a winding structure 460 and a conductive shield 452. The winding structure 460 includes a plurality of conductive windings (“windings”) that can be arranged in layers of a PCB around the core 403. The inductor structure 450 adopts or tracks a substantially circular shape and is positioned around a central leg 405 of the core 403. In other words, inductor structure portion 450A and inductor structure portion 450B, which are structurally identical, are positioned around the central leg 405. Based on the structure of the core 403, which is an EQ shaped core in this case, the inductor structure 450 can track different shapes such as oval, square-like, octagonal, and hexagonal, among others.

The windings of the winding structure 460 include metallic windings such as copper windings and can include an arrangement of individual windings with each winding implemented in a separate metallic layer or trace of the PCB. In some cases, multiple windings can be implemented in the same metallic layer. In FIG. 4, the windings of the winding structure 460 include four windings implemented in four separate metallic layers of the PCB and arranged around the core 403, but the winding structure 460 is not limited to four windings and can include less than or greater than four windings. The core 403 can include an EI shaped core or an EQ shaped core as stated above. However, the planar inductor 400 is not limited thereto, and the windings can be designed to be arranged around different types of cores such as a UI shaped core and other types of cores.

The conductive shield 452 encloses or encases the winding structure 460. So that the conductive shield 452 can effectively encase or completely enclose the winding structure 160, a geometric shape of the conductive shield 452 tracks or adopts a geometric shape of the winding structure 460. For example, if the winding structure 160 tracks a circular shape, the conductive shield 452 can track a circular shape. The conductive shield 452 includes an upper conductive shield layer 453, a lower conductive shield layer 454, inner conductive shield rings 456, and outer conductive shield rings 458. The upper conductive shield layer 453, the lower conductive shield layer 454, the inner conductive shield rings 456, and the outer conductive shield rings 458 can all be electrically coupled to each other, and function to contain electric fields emanating from the planar inductor 100 to mitigate undesirable electromagnetic couplings to other components and conductors within a power converter. For example, the conductive shield 452 can function to contain electric fields emanating from the planar inductor 400 during a power conversion operation to prevent parasitic capacitive coupling from the planar inductor 400 to an EMI filter and other auxiliary circuits that can be present within a power converter such as gate drivers and sensing circuits, thereby decreasing interference with these circuitries and improving reliability of the power converter. The conductive shield 452 can be manufactured with the planar inductor 400 as an integrated metallic shield using standard PCB manufacturing processes, to improve EMC with minimal impact on system cost and complexity.

The upper conductive shield layer 453 is disposed over the winding structure 460 in a first direction. For example, the upper conductive shield layer 453 can be implemented in a metallic layer of a PCB above a metallic layer of an uppermost or a top winding of the winding structure 460. The lower conductive shield layer 454 is disposed under the winding structure 460 in a second direction opposite the first direction. For example, the lower conductive shield layer 454 can be implemented in a metallic layer of a PCB below a metallic layer of a lowermost or a bottom winding of the winding structure 460. The inner conductive shield rings 456 are implemented co-planar and on the same metallic layers as the winding structure 460 and adjacent to central leg 405. The outer conductive shield rings 458 are implemented co-planar and on the same metallic layers as the winding structure 460 and around and outside of the conductive windings of the winding structure 460 and positioned away from the central leg 405.

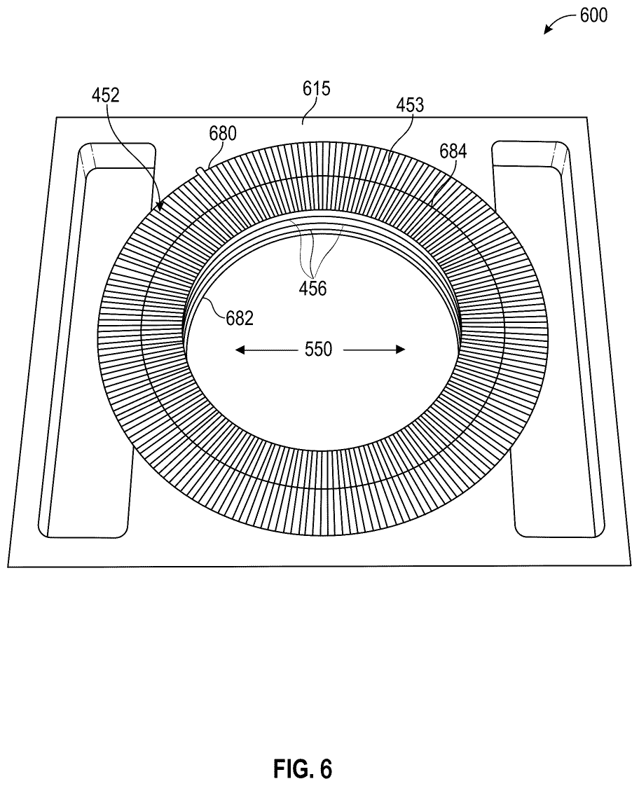

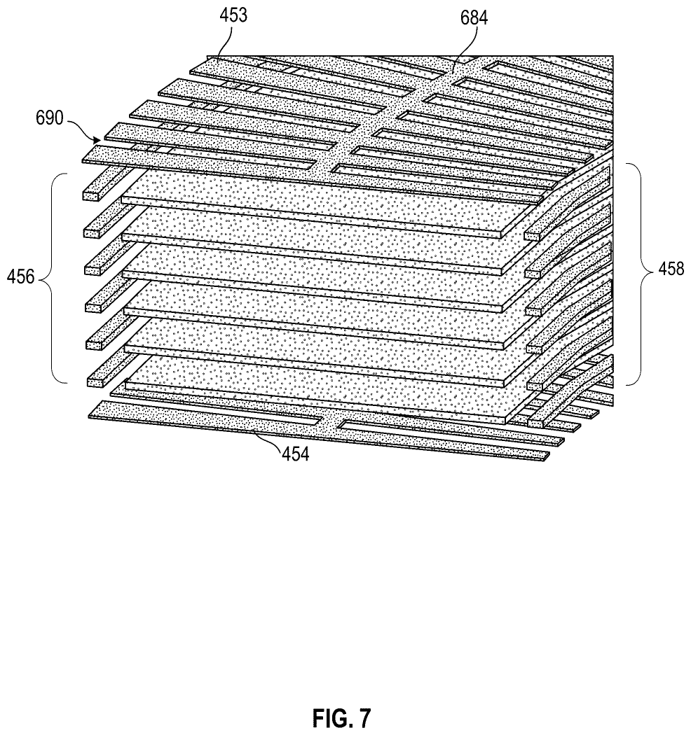

In contrast to the upper conductive shield layer 153 and the lower conductive shield layer 154 of the conductive shield 152, the upper conductive shield layer 453 and the lower conductive shield layer 454 are patterned with radial cuts. In contrast to the inner edge shield plate 156 and/or the outer edge shield plate 158, which includes a single conductive plate, the inner conductive shield rings 456 and the outer conductive shield rings 458 each include separated conductive traces disposed around the winding structure 460. The structure of the conductive shield 452 is discussed in greater detail with respect to FIGS. 6 and 7, provided below.

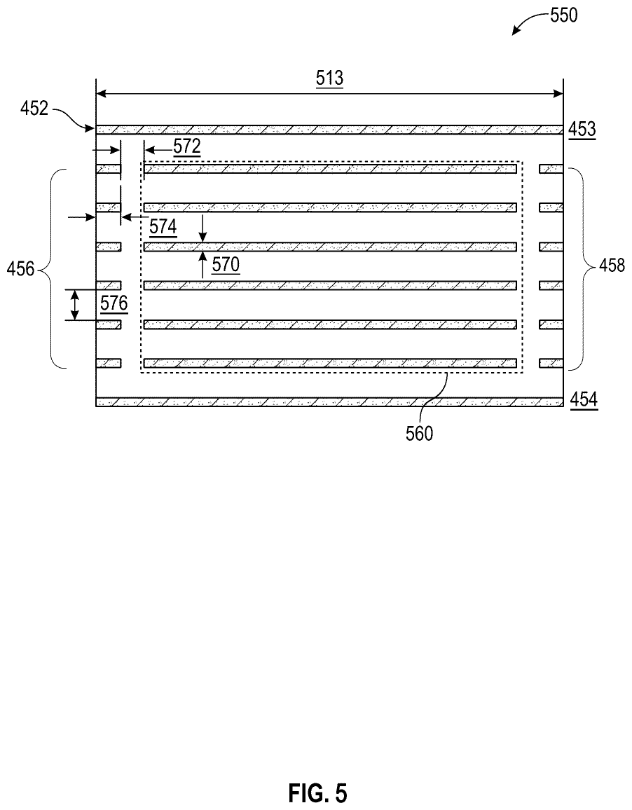

FIG. 5 depicts a cross-sectional PCB schematic of an example inductor structure implementing the conductive shield shown in FIG. 4, FIG. 6 depicts a perspective view of a planar inductor implementing the inductor structure shown in FIG. 5, and FIG. 7 depicts a sectional view of the planar inductor shown in FIG. 6, according to various embodiments of the present disclosure. Referring to FIG. 5, an inductor structure 550 is similar to the inductor structure portions 450A or 450B but includes a winding structure 560 with six conductive windings instead of the four windings in the inductor structure 450. The inductor structure 550 can be implemented in the planar inductor 400 shown in FIG. 4. The inductor structure 550 includes the conductive shield 452, which encases or completely encloses the winding structure 560.

The upper conductive shield layer 453 is disposed over the winding structure 560 in a first direction. For example, the upper conductive shield layer 453 can be implemented in a metallic layer of a PCB above an uppermost or top winding of the winding structure 560. The lower conductive shield layer 454 is disposed under the winding structure 560 in a second direction opposite the first direction. For example, the lower conductive shield layer 454 can be implemented in a metallic layer of a PCB below a lowermost or bottom winding of the winding structure 560. The inner conductive shield rings 456 are disposed within and around the winding structure 560 and can be positioned adjacent to the central leg 405. The outer conductive shield rings 458 are disposed around and outside of the winding structure 560 and can be positioned away from the central leg 405.

The winding structure 560 is separated from the inner conductive shield rings 456 and the outer conductive shield rings 458 by an edge clearance 572. The windings in the winding structure 560 are separated from each other by a dielectric thickness 576. Additionally, the conductive traces of the inner conductive shield rings 456 and the outer conductive shield rings 458 are separated from each other by the same dielectric thickness 576. Each of the windings in the winding structure 560, the upper conductive shield layer 453, the lower conductive shield layer 454, and each conductive trace of the inner conductive shield rings 456 and the outer conductive shield rings 458 has a winding thickness 570 in at least one example which can vary based on manufacturer specifications or based on the application of the inductor structure 550. The thickness of the upper conductive shield layer 453 is generally equal to the thickness of lower conductive shield layer 454. The thickness of individual windings of the winding structure 560, the inner conductive shield rings 456, and the outer conductive shield rings 458 is generally equal to, but may be less than or greater than, the thickness of the upper conductive shield layer 453 and lower conductive shield layer 454. In one example, the winding thickness 570 of each of the windings in the winding structure 560, the upper conductive shield layer 453, the lower conductive shield layer 454, and each conductive trace of the inner conductive shield rings 456 and the outer conductive shield rings 458 can range from 17 microns to 140 microns, commensurate with about a half ounce (oz) copper to four oz copper. Each conductive trace of the inner conductive shield rings 456 and the outer conductive shield rings 458 has a width 574. The inner conductive shield rings 456 and the outer conductive shield rings 458 form a shield around inner and outer circumference formed by the winding structure 560. The conductive shield 452 has a winding window 513, which defines the total cross-sectional width of the inductor winding structure 550 including windings, conductive shielding, and associated clearances.

The upper conductive shield layer 453, the lower conductive shield layer 454, and each conductive trace of the inner conductive shield rings 456 and the outer conductive shield rings 458 may or may not be equal in thicknesses. The winding structure 560 includes six conductive windings in the example shown, although the winding structure 560 can include greater or fewer than six windings. The outer conductive shield rings 458 include the same number of separated conductive traces as the total number of windings of the winding structure 560. Similarly, the inner conductive shield rings 456 includes the same number of separated conductive traces as the total number of windings of the winding structure 560. Thus, in the example shown, the outer conductive shield rings 458 and the inner conductive shield rings 456 both include six separated conductive traces.

The outer conductive shield rings 458 are aligned with the winding structure 560. That is, the separated conductive traces of the outer conductive shield rings 458 are aligned with the windings of the winding structure 560. Similarly, the inner conductive shield rings 456 are aligned with the winding structure 560. That is, the separated conductive traces of the inner conductive shield rings 456 are aligned with the windings of the winding structure 560. The upper conductive shield layer 453 and the lower conductive shield layer 454 help prevent electric fields of the planar inductor 400 from escaping vertically from the PCB. The inner conductive shield rings 456 and the outer conductive shield rings 458 help prevent electric fields of the planar inductor 400 escaping laterally through the PCB.

In FIG. 6, a planar inductor 600 is implemented in a PCB 615. The planar inductor 600 includes the conductive shield 452 and is representative of the inductor structure 450 or 550. The following description is provided with respect to the inductor structure 550, but this description is applicable to the inductor structure 450 as well. As the winding structure 560 tracks a circular shape, the conductive shield 452 also tracks a circular shape to enclose the winding structure 560. The inner conductive shield rings 456 are disposed within and around the winding structure 560 and form an inner circumference 682 of the conductive shield 452. The outer conductive shield rings 458 are disposed around and outside the winding structure 560 and form an outer circumference 680 of the conductive shield 452. An intermediary section 684 of the upper conductive shield layer 453 forms a loop between the outer circumference 680 and the inner circumference 682. The intermediary section 684 is approximately halfway between the outer circumference 680 and the inner circumference 682. The lower conductive shield layer 454 includes a similar intermediary section that is approximately halfway between the outer circumference 680 and the inner circumference 682.

Similar to the conductive shield 152, the conductive shield 452 includes a termination (not depicted) which can be used to connect to a DC or AC Vₒ terminal of a power converter. The conductive shield 452 similarly includes a separation or cut (not depicted) that extends from an edge of the outer circumference 680 to an edge of the inner circumference 682. The cut physically separates the conductive shield 452 into two sections with respect to a shield termination to prevent eddy currents and circulation of large current that could potentially flow around the loop formed by the conductive shield 452, which could otherwise degrade or destroy its performance.

Referring to FIG. 7, the upper conductive shield layer 453 is patterned with radial cuts extending from the outer circumference 680 or the inner circumference 682 to the intermediary section 684. The lower conductive shield layer 454 is patterned with similar radial cuts extending from the outer circumference 680 or the inner circumference 682 to the intermediary section of the lower conductive shield layer 454. The radial cuts help minimize eddy currents in the conductive shield 452 and form a fishbone-like pattern for the conductive shield 452. It should be noted that the conductive shield 452 can include other types of patterns and not just radial cuts as described above. For example, other cut patterns can be applied to the upper conductive shield layer 453 and the lower conductive shield layer 454 as long as cuts or separations are present in each of the shield layers 453 and 454.

It should be noted that the planar inductors according to the embodiments can include inductor structures that are combinations of the inductor structures 150 and 450. For example, a planar inductor according to the embodiments can include solid upper and lower conductive shield layers (e.g., the upper conductive shield layer 153 and the lower conductive shield layer 154) that are not patterned and also use conductive inner and outer shield rings with separated conductive traces (e.g., the inner conductive shield rings 456 and the outer conductive shield rings 458). In another example, a planar inductor according to the embodiments can include patterned upper and lower conductive shield layers (e.g., the upper conductive shield layer 453 and the lower conductive shield layer 454) and solid inner and outer edge shield plates (e.g., the inner edge shield plate 156 and the outer edge shield plate 158).

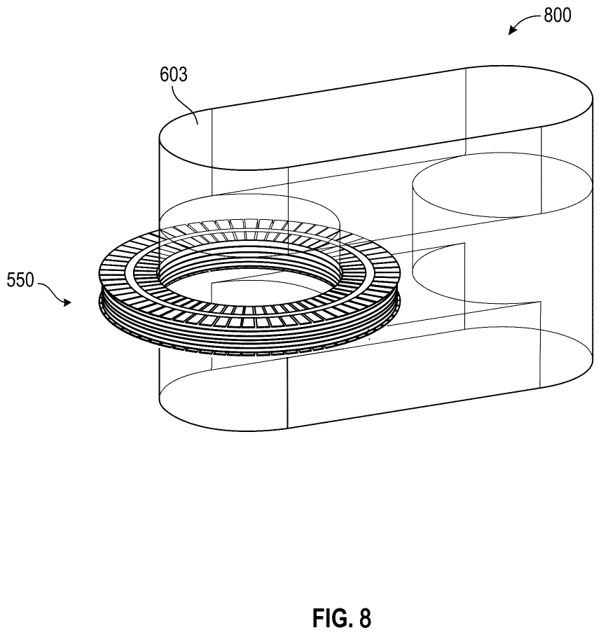

FIG. 8 depicts a planar inductor 800 with a patterned conductive shield implemented with a UI shaped core according to various embodiments of the present disclosure. The planar inductor 800 includes the inductor structure 550 which is implemented with a UI shaped core 603. The core 603 is a magnetic core with a plurality of core legs. In particular, the inductor structure 550 is positioned around one core leg of the plurality of core legs of the core 603. Although a UI shaped core is depicted, the planar inductor 800 can include different types of cores such as EQ and EI shaped cores, among others types of cores, in which the inductor structure 550 can be implemented with. The core 603 is provided as a representative example and can be extended to include any number of legs, as needed, based on the number of inductor structures needed for the planar inductor 800. The core 603 can be embodied as a material of high magnetic permeability, such as a ferromagnetic material like iron, laminated silicon steel, laminated iron sheets, or other solid or laminated ferromagnetic ceramic, metal, metal alloy, or related material(s).

The described embodiments include a planar inductor structure incorporating conductive shields integrated within a PCB to contain the inductor's electric field to mitigate undesirable electromagnetic couplings to other components and conductors within a power converter. This shielded structure can improve the EMC and reliability of the power converter by decreasing interference with these other circuitries and components. In one embodiment, the conductive shield can be implemented using solid shield layers and PCB edge plating to form a complete shield around the conductive windings of the winding structure. To reduce loss generated by eddy currents in the shield, the conductive shields of the embodiments can also be implemented using patterned shield layers and conductive inner and outer shield rings that form a shield around the inner and outer circumferences of the winding structure. The planar inductors of the embodiments effectively contain the electric field produced by the inductor to prevent parasitic capacitive couplings to other areas of the converter circuit.

The planar inductors (e.g., the planar inductors 100, 300, 400, and 600), when implemented in practice, will generally include PCB dielectric material as part of the PCB inductor structure. This PCB dielectric material is not specifically illustrated or described in detail herein for the sake of clarity for the inductor structure. Additionally, the planar inductors can include magnetic components having more than one set of conductive windings, such as coupled inductors and transformers. For example, the conductive shields (e.g., the conductive shields 152 or 452) of the embodiments and their concepts can be applied to winding components of transformers. In other words, the conductive shields can be extended to encase or enclose the winding components of transformers and provide similar system benefits in terms of EMC and reliability as what was described with respect to the inductors herein. Further, the conductive shields of the embodiments can be applied to a variety of other shapes of windings and winding structures, such as rectangular, oval, square-like, and hexagonal, among others. The planar inductors of the embodiments can also include or be implemented with other shapes of magnetic cores, such as E-cores, U-cores, I-cores, EE-cores, UI cores, EQ cores, EI cores, UI cores, and EE cores, among other types of cores. The structures and shapes provided in the embodiments are provided as examples only and can be extended to encompass a wide range of other shapes and structures, such as the ones described above, while staying within the concepts and principles described in the disclosure.

When adopted in a switch-mode power converter, one implementation of the planar inductor of the embodiments is demonstrated to reduce a converter's common mode noise emissions by up to 25 dBV. Meanwhile, the efficiency of the converter adopting one or more of the planar inductors of the embodiments has an efficiency only 0.14% lower than an equivalent converter using a planar inductor with no shielding. The embodiments can be implemented for a wide range of planar inductor designs with various winding patterns and magnetic core geometries. The embodiments provide an attractive means to improve the EMC and reliability of switching power converters in a wide range of applications, such as offline power supplies, electric vehicle chargers, and grid-tied converters.

The features, structures, or characteristics described above may be combined in one or more embodiments in any suitable manner, and the features discussed in the various embodiments are interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims. If a component is described as having “one or more” of the component, it is understood that the component can be referred to as “at least one” component.

The terms “first,” “second,” etc. are used only as labels, rather than a limitation for a number of the objects. It is understood that if multiple components are shown, the components may be referred to as a “first” component, a “second” component, and so forth, to the extent applicable.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A planar inductor, comprising:
a winding structure comprising a plurality of conductive windings arranged in layers of a printed circuit board (PCB) around a core, the plurality of conductive windings comprising at least a top winding and a bottom winding; and
a conductive shield encasing the winding structure, the conductive shield comprising:
an upper conductive shield layer disposed over the winding structure in a first direction;
a lower conductive shield layer disposed under the winding structure in a second direction opposite the first direction;
an inner conductive shield disposed within and around the plurality of conductive windings; and
an outer conductive shield disposed around and outside the plurality of conductive windings.

2. The planar inductor of claim 1, wherein a geometric shape of the conductive shield tracks a geometric shape of the winding structure.

3. The planar inductor of claim 1, wherein a thickness of the upper conductive shield layer is different than a thickness of the inner conductive shield or the outer conductive shield.

4. The planar inductor of claim 1, wherein:
the upper conductive shield layer, the lower conductive shield layer, the inner conductive shield, and the outer conductive shield are electrically coupled to each other; and
the conductive shield is electrically coupled to an input or output voltage potential of a power converter.

5. The planar inductor of claim 1, wherein the conductive shield is configured to mitigate or contain an electric field emanating from the winding structure during a power conversion operation.

6. The planar inductor of claim 1, wherein one of the upper or the lower conductive shield layers is patterned with a plurality of radial cuts.

7. The planar inductor of claim 6, wherein the plurality of radial cuts extends from an outer circumference of the conductive shield to an intermediary section of the upper or the lower conductive shield layers.

8. The planar inductor of claim 6, wherein:
the inner conductive shield comprises a plurality of separate conductive traces disposed around and within the plurality of conductive windings; and
the outer conductive shield comprises a plurality of separate conductive traces disposed around and outside the plurality of conductive windings.

9. The planar inductor of claim 1, wherein the inner conductive shield and the outer conductive shield are uniform structures without variation in surface characteristics.

10. The planar inductor of claim 1, wherein the upper conductive shield layer and the lower conductive shield layer are uniform structures without variations in surface characteristics.

11. The planar inductor of claim 1, wherein a thickness of the upper conductive shield layer is equal to, greater than, or less than a thickness of the inner conductive shield or the outer conductive shield.

12. A planar inductor, comprising:
a winding structure comprising a plurality of conductive windings arranged in layers of a printed circuit board (PCB) around a core, the plurality of conductive windings comprising at least a top winding and a bottom winding; and
a patterned conductive shield encasing the winding structure, the patterned conductive shield comprising:
an upper conductive shield layer disposed over the winding structure in a first direction, the upper conductive shield layer comprising a plurality of radial cuts;
a lower conductive shield layer disposed under the winding structure in a second direction opposite the first direction, the lower conductive shield layer comprising a plurality of radial cuts;
an inner conductive shield disposed within and around the plurality of conductive windings; and
an outer conductive shield disposed around and outside the plurality of conductive windings.

13. The planar inductor of claim 12, wherein the plurality of radial cuts of the upper conductive shield layer extends from an outer circumference of the patterned conductive shield to an intermediary section of the upper conductive shield layer.

14. The planar inductor of claim 12, wherein the plurality of radial cuts of the lower conductive shield layer extends from an inner circumference of the patterned conductive shield to an intermediary section of the lower conductive shield layer.

15. The planar inductor of claim 13, wherein:
the outer conductive shield comprises a plurality of separate conductive traces disposed around and outside the plurality of conductive windings; and
the outer conductive shield forms the outer circumference of the patterned conductive shield.

16. The planar inductor of claim 14, wherein:
the inner conductive shield comprises a plurality of separate conductive traces disposed within and around the plurality of conductive windings; and
the inner conductive shield forms the inner circumference of the patterned conductive shield.

17. The planar inductor of claim 12, wherein a thickness of the upper conductive shield layer is equal to a thickness of the lower conductive shield layer.

18. The planar inductor of claim 12, wherein:
the upper conductive shield layer, the lower conductive shield layer, the inner conductive shield, and the outer conductive shield are electrically coupled to each other; and
the patterned conductive shield is electrically coupled to an output voltage potential of a power converter.

19. The planar inductor of claim 12, wherein a thickness of the lower conductive shield layer is equal to, greater than, or less than a thickness of the inner conductive shield or a thickness of the outer conductive shield.

20. The planar inductor of claim 12, wherein the core is an EQ shaped core or a UI shaped core.
